(19) United States
(12) Patent Application Publication
(10) Pub. No.: US 2015/0309972 A1
(43) Pub. Date: Oct. 29, 2015

(54) METHODS AND APPARATUS FOR ASSOCIATING A DOCUMENT WITH A DATABASE FIELD VALUE

(71) Applicant: kCura Corporation, Chicago, IL (US)

(72) Inventors: Sam John, Chicago, IL (US); Mark Zider, Lindenhurst, IL (US); Charles Connor, Chicago, IL (US); Charles Geter, Chicago, IL (US); Casey Bubert, Chicago, IL (US); Ted Hogan, Chicago, IL (US)

(73) Assignee: kCura Corporation, Chicago, IL (US)

(21) Appl. No.: 14/260,356

(22) Filed: Apr. 24, 2014

(51) Int. Cl. G06F 17/24; G06F 3/0484; G06F 3/0488

(52) U.S. Cl. CPC G06F 17/24; G06F 3/04883; G06F 3/04842

(57) ABSTRACT

Methods and apparatus for associating a document with a database field value are disclosed. For example, a user of an electronic record management system may be viewing a document and/or metadata associated with a document on a primary display, such as a desktop computer display. In addition, the user may be viewing various database fields and/or potential values for those fields on a secondary display, such as a tablet device. The user can then select certain user interface objects, such as buttons, and/or perform certain predefined user gestures, such as a left swipe, on the secondary display. As a result, one or more database fields associated with the document are populated with one or more values. For example, the user may be executing an electronic document review application on a desktop computer while coding documents using a tablet device synchronized to the electronic document review application via the Internet.

The present disclosure relates in general to databases, and, in particular, to methods and apparatus for associating a document with a database field value.

### BACKGROUND

The vast majority of documents we create and/or archive are stored electronically. In order to quickly find certain documents, the relevant data from these documents is typically extracted, catalogued, and organized in a database to make them searchable. Once the documents are in the database, certain “relevant” documents must be “tagged” or “coded.” For example, in a lawsuit, certain document may be coded as “privileged.” In some circumstances, these databases can be very large. For example, a law suit may involve millions of documents. Coding documents in these large databases can be problematic.

Typically, users review the documents on a computing device and code each document using the same computing device. For example, the user may view a document in a window on the computing device display and select a menu item or press a key to indicate the document is either “responsive” or “non-responsive” to a legal discovery request. However, using the same computing device to both view the document and code the document can slow down the coding process and create user fatigue.

### BRIEF DESCRIPTION OF THE DRAWINGS

FIG. 1 is a block diagram of an example network communication system.

FIG. 2 is a block diagram of an example computing device.

FIG. 3 is a flowchart of an example process for associating a document with a database field value.

FIG. 4 is a flowchart of another example process for associating a document with a database field value.

FIG. 5 is a screen shot of an example primary display showing a document displayed in an electronic document review application.

FIG. 6 is a screen shot of an example secondary display showing buttons and a gesture that may be used to code the document being displayed by the primary display.

### DETAILED DESCRIPTION OF THE PREFERRED EMBODIMENTS

Briefly, methods and apparatus for associating a document with a database field value are disclosed. For example, a user of an electronic record management system may be viewing a document and/or metadata associated with a document on a primary display, such as a desktop computer display. In addition, the user may be viewing various database fields and/or potential values for those fields on a secondary display, such as a tablet device. The user can then select certain user interface objects, such as buttons, and/or perform certain predefined user gestures, such as a left swipe, on the secondary display. As a result, one or more database fields associated with the document are populated with one or more values. For example, the user may be executing an electronic document review application on a desktop computer while coding documents using a tablet device synchronized to the electronic document review application via the Internet.

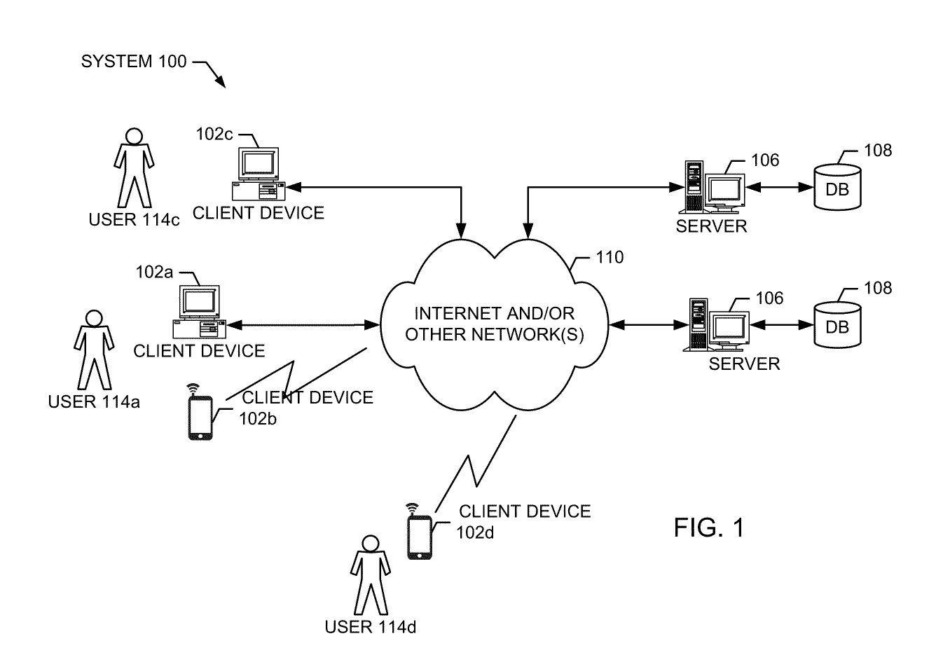

Turning now to the figures, the present system is most readily realized in a network communication system 100. A block diagram of certain elements of an example network communications system 100 is illustrated in FIG. 1. The illustrated system 100 includes one or more client devices 102 (e.g., computer, television, camera, phone), one or more web servers 106, and one or more databases 108. Each of these devices may communicate with each other via a connection to one or more communications channels 110 such as the Internet or some other wired and/or wireless data network, including, but not limited to, any suitable wide area network or local area network. It will be appreciated that any of the devices described herein may be directly connected to each other instead of over a network.

The web server 106 stores a plurality of files, programs, and/or web pages in one or more databases 108 for use by the client devices 102 as described in detail below. The database 108 may be connected directly to the web server 106 and/or via one or more network connections. The database 108 stores data as described in detail below.

One web server 106 may interact with a large number of client devices 102. Accordingly, each server 106 is typically a high end computer with a large storage capacity, one or more fast microprocessors, and one or more high speed network connections. Conversely, relative to a typical server 106, each client device 102 typically includes less storage capacity, a single microprocessor, and a single network connection.

In this example, user 114a is using client device 102a and client device 102b. For example, user 114a may be reviewing documents displayed on a desktop display of client device 102a and coding those documents using a touch screen on client device 102b.

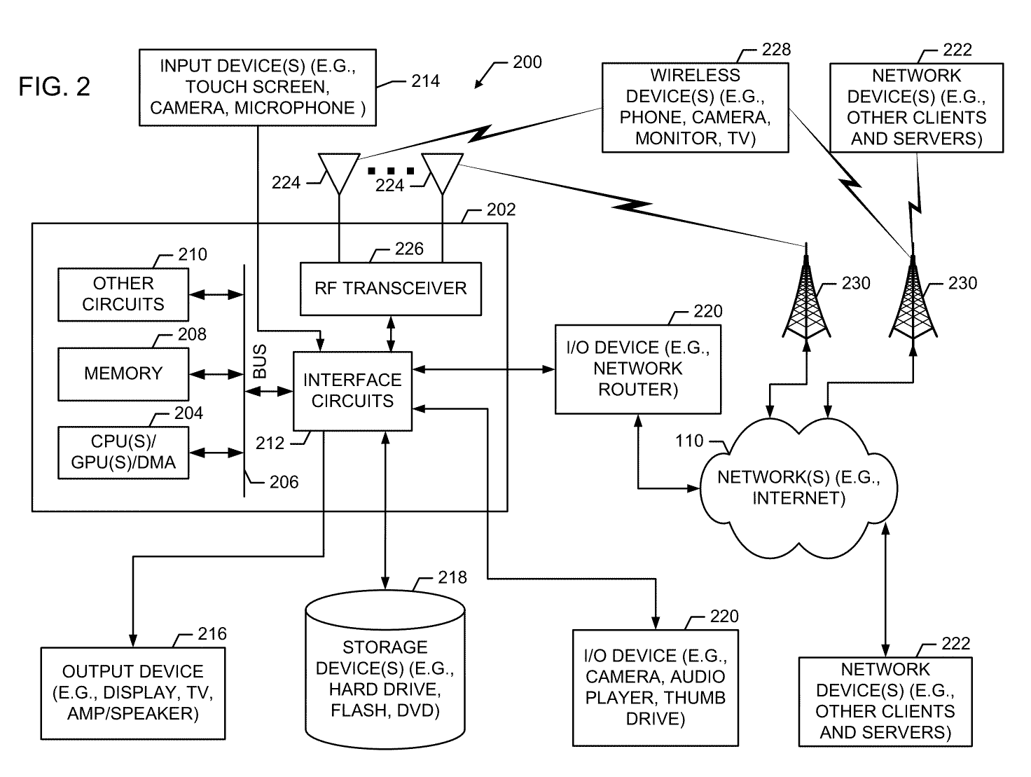

Each of the devices illustrated in FIG. 1 (e.g., clients 102 and/or servers 106) may include certain common aspects of many computing devices such as microprocessors, memories, input devices, output devices, etc. FIG. 2 is a block diagram of an example computing device. The example computing device 200 includes a main unit 202 which may include, if desired, one or more processing units 204 electrically coupled by an address/data bus 206 to one or more memories 208, other computer circuitry 210, and one or more interface circuits 212. The processing unit 204 may include any suitable processor or plurality of processors. In addition, the processing unit 204 may include other components that support the one or more processors. For example, the processing unit 204 may include a central processing unit (CPU), a graphics processing unit (GPU), and/or a direct memory access (DMA) unit.

The memory 208 may include various types of non-transitory memory including volatile memory and/or non-volatile memory such as, but not limited to, distributed memory, read-only memory (ROM), random access memory (RAM) etc. The memory 208 typically stores a software program that interacts with the other devices in the system as described herein. This program may be executed by the processing unit 204 in any suitable manner. The memory 208 may also store digital data indicative of documents, files, programs, web pages, etc. retrieved from a server and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, camera, voice recognition system, accelerometer, global positioning system (GPS), and/or any other suitable input device.

One or more displays, printers, speakers, monitors, televisions, high definition televisions, and/or other suitable output devices 216 may also be connected to the main unit 202 via the interface circuit 212. One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the device 200. The computing device 200 may also exchange data with one or more input/output (I/O) devices 220, such as network routers, camera, audio players, thumb drives etc.

The computing device 200 may also exchange data with other network devices 222 via a connection to a network 110. The network connection may be any type of network connection, such as an Ethernet connection, digital subscriber line (DSL), telephone line, coaxial cable, wireless base station 230, etc. Users 114 of the system 100 may be required to register with a server 106. In such an instance, each user 114 may choose a user identifier (e.g., e-mail address) and a password which may be required for the activation of services. The user identifier and password may be passed across the network 110 using encryption built into the user's browser. Alternatively, the user identifier and/or password may be assigned by the server 106.

In some embodiments, the device 200 may be a wireless device 200. In such an instance, the device 200 may include one or more antennas 224 connected to one or more radio frequency (RF) transceivers 226. The transceiver 226 may include one or more receivers and one or more transmitters operating on the same and/or different frequencies. For example, the device 200 may include a blue tooth transceiver 216, a Wi-Fi transceiver 216, and diversity cellular transceivers 216. The transceiver 226 allows the device 200 to exchange signals, such as voice, video and any other suitable data, with other wireless devices 228, such as a phone, camera, monitor, television, and/or high definition television. For example, the device 200 may send and receive wireless telephone signals, text messages, audio signals and/or video signals directly and/or via a base station 230.

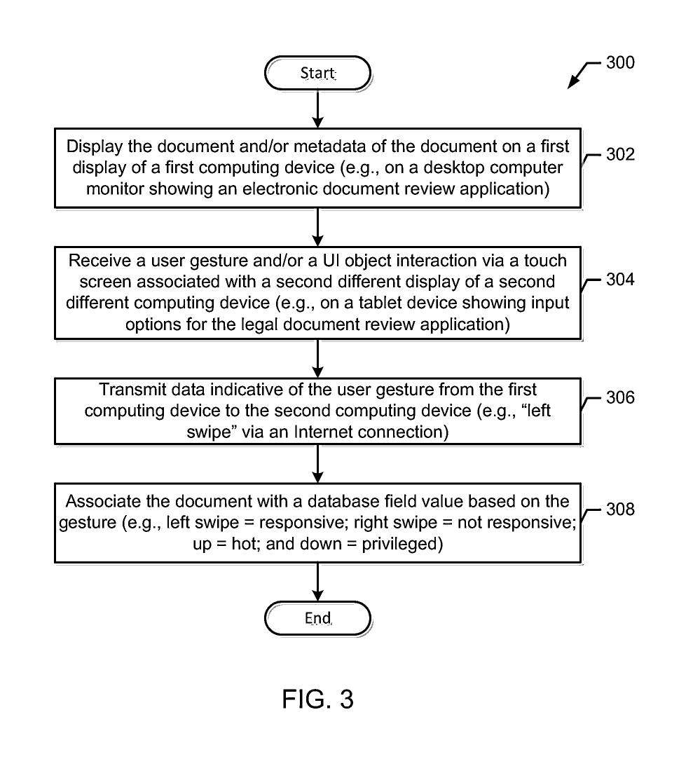

FIG. 3 is a flowchart of an example process for associating a document with a database field value. The process 300 may be carried out by one or more suitably programmed processors, such as a CPU executing software (e.g., block 204 of FIG. 2). The process 300 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 300 is described with reference to the flowchart illustrated in FIG. 3, it will be appreciated that many other methods of performing the acts associated with process 300 may be used. For example, the order of many of the operations may be changed, and some of the operations described may be optional.

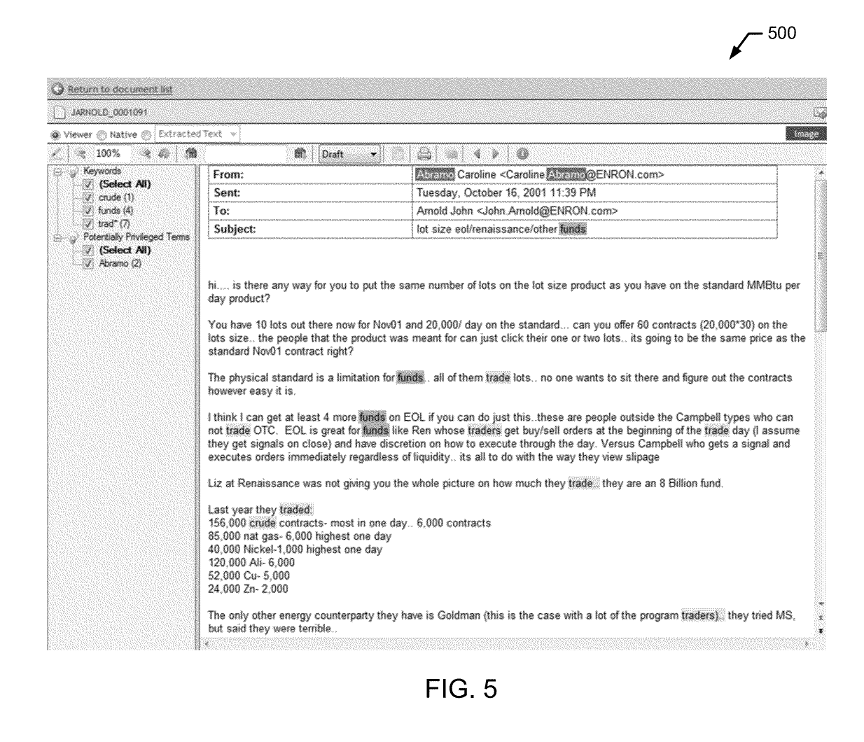

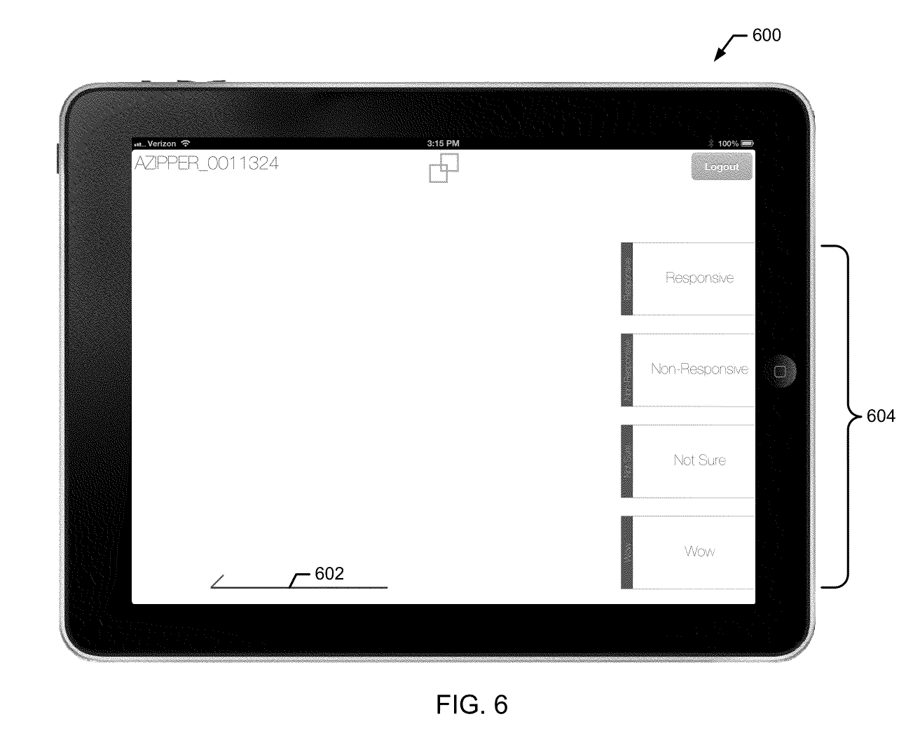

In this example, the process 300 begins when a first computing device 102a displays a document and/or metadata of the document on a first display (block 302). For example, the document and/or metadata may be displayed on a desktop computer monitor showing an electronic document review application (see FIG. 5). While the document and/or metadata are displayed by the first computing device 102a, a touch screen of a second different computing device 102b receives a user gesture and/or a user interface object interaction (block 304). For example, a tablet device may receive a “left swipe” user gesture or a “Responsive” touch screen button press (see FIG. 6). The second computing device 102b then transmits data indicative of the user gesture to the first computing device 102a (block 306). For example, the touch screen device may send data indicative of a “left swipe” user gesture via a network, such as the Internet, to the desktop device. The first computing device 102a then associates the document with a database field value based on the gesture data received from the second computing device 102b (block 308). For example, a left swipe may code the document as “responsive”; a right swipe may code the document as “not responsive”; an upward swipe may code the document as “hot”; and downward swipe may code the document as “privileged.”

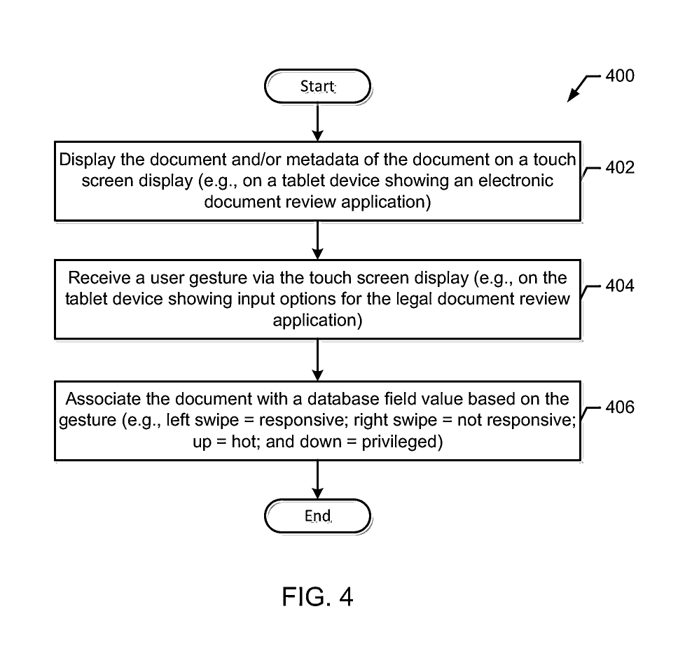

FIG. 4 is a flowchart of another example process for associating a document with a database field value. The process 400 may be carried out by one or more suitably programmed processors, such as a CPU executing software (e.g., block 204 of FIG. 2). The process 400 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 400 is described with reference to the flowchart illustrated in FIG. 4, it will be appreciated that many other methods of performing the acts associated with process 400 may be used. For example, the order of many of the operations may be changed, and some of the operations described may be optional.

In this example, the process 400 begins when a touch screen display 214 of a computing device 102d displays a document and/or metadata of the document (block 402). For example, the document and/or metadata may be displayed on a tablet device showing an electronic document review application (see FIG. 5). While the document and/or metadata are displayed by the touch screen display 214, the touch screen display 214 receives a user gesture (block 404). For example, a tablet device may receive a “left swipe” user gesture (see FIG. 6). The computing device 102d then associates the document with a database field value based on the user gesture received from the touch screen display 214 (block 406). For example, a left swipe may code the document as “responsive”; a right swipe may code the document as “not responsive”; an upward swipe may code the document as “hot”; and downward swipe may code the document as “privileged.”

FIG. 5 is a screen shot of an example primary display showing a document displayed in an electronic document review application. In this example, FIG. 5 is showing an email message. However, any suitable document may be displayed by the primary display. In addition, or alternately, metadata associated with the document may be displayed. For example, time stamps associated with the document, one or more authors of the document, the number of pages in the document, file size, etc.

FIG. 6 is a screen shot of an example secondary display showing a user gesture 602 and touch screen buttons 604 that may be used to code the document being displayed by the primary display. In this example, a left swipe user gesture 602 is symbolically shown. In some embodiments, the user gesture may be performed anywhere on the display. In some embodiments, the user gesture must be performed in a designated area of the display. In some embodiments, feedback graphics, such as lines, arrows, and/or words indicative of a field value associated with the gesture are displayed. In some embodiments, no feedback graphics are displayed. Although touch screen buttons 604 are illustrated in this example, any suitable user interface object(s), such as radio buttons, checkboxes, and/or drop down menus may be used.

Although coding documents in an electronic document review application is used as the primary example though out this description, a person of ordinary skill in the art will readily appreciate that the secondary screen may be synchronized to the primary screen for any other suitable purpose. For example, a user may select documents from the secondary screen. For example, the user may select documents using a list of documents in a folder view, a saved search, and/or a review batch. In another example, the user may use the secondary screen to view his/her assigned document batches, checkin/checkout document batches, and/or review document batches. In yet another example, the user may use the secondary screen to view/edit values of fields in a coding layout, search the contents of documents, and/or move forward/back between documents. For example, a touch screen buttons may be used to code documents and left/right swipe gestures may be used to move forward/back between documents.

In summary, persons of ordinary skill in the art will readily appreciate that methods and apparatus for associating a document with a database field value have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of associating a document with a database field value, the method comprising:
displaying at least one of the document and metadata associated with the document on a first display of a first computing device;
receiving at least one of a user gesture and a user interface object interaction via a touch screen associated with a second different display of a second different computing device;
transmitting data indicative of the user gesture from the second computing device to the first computing device; and
associating the document with the database field value based on the gesture.

2. The method of claim 1, wherein the user gesture is user definable.

3. The method of claim 1, wherein associating the document with the database field value includes coding the document in an electronic document review application.

4. The method of claim 3, wherein coding the document based on the gesture includes coding the document with a first code if the gesture is a swipe in a first direction and coding the document with a second different code if the gesture is a swipe in a second different direction.

5. The method of claim 4, wherein the first direction is opposite of the second direction.

6. The method of claim 4, wherein the first code and the second code are user definable.

7. The method of claim 3, wherein coding the document includes coding the document as at least one of privileged, responsive, not responsive, and hot.

8. The method of claim 1, wherein displaying the document on the first display includes displaying the document in an electronic document review application.

9. The method of claim 1, wherein displaying the document on the first display includes displaying the document on a desktop monitor and receiving the user gesture via the touch screen includes receiving the user gesture via a tablet device.

10. The method of claim 1, wherein transmitting data indicative of the user gesture from the first computing device to the second computing device includes transmitting the data via a network.

11. The method of claim 10, wherein transmitting the data via the network includes transmitting the data via the Internet.

12. An apparatus for associating a document with a database field value, the apparatus comprising:
a processor;
a network interface operatively coupled to the processor; and
a memory device operatively coupled to the processor, the memory device storing instructions to cause the processor to:
display at least one of the document and metadata associated with the document on a first display of a first computing device;
receive at least one of a user gesture and a user interface object interaction via a touch screen associated with a second different display of a second different computing device;
transmit data indicative of the user gesture from the second computing device to the first computing device; and
associate the document with the database field value based on the gesture.

13. The apparatus of claim 12, wherein the user gesture is user definable.

14. The apparatus of claim 12, wherein associating the document with the database field value includes coding the document in an electronic document review application.

15. The apparatus of claim 14, wherein the instructions are structured to cause the processor to code the document with a first code if the gesture is a swipe in a first direction and coding the document with a second different code if the gesture is a swipe in a second different direction.

16. The apparatus of claim 15, wherein the first direction is opposite of the second direction.

17. The apparatus of claim 15, wherein the first code and the second code are user definable.

18. The apparatus of claim 14, wherein the instructions are structured to cause the processor to code the document as at least one of privileged, responsive, not responsive, and hot.

19. The apparatus of claim 12, wherein the instructions are structured to cause the processor to display the document in an electronic document review application.

20. The apparatus of claim 12, wherein the instructions are structured to cause the processor to display the document on a desktop monitor and receiving the user gesture via the touch screen includes receiving the user gesture via a tablet device.

21. The method of claim 12, wherein the instructions are structured to cause the processor to transmit the data indicative of the user gesture from the first computing device to the second computing device via a network.

22. The apparatus of claim 12, wherein the instructions are structured to cause the processor to transmit the data indicative of the user gesture via the Internet.

23. A non-transitory computer readable medium storing instructions structured to cause a computing device to:
display at least one of the document and metadata associated with the document on a first display of a first computing device;
receive at least one of a user gesture and a user interface object interaction via a touch screen associated with a second different display of a second different computing device;
transmit data indicative of the user gesture from the second computing device to the first computing device; and
associate the document with the database field value based on the gesture.

24. The computer readable medium of claim 23, wherein the user gesture is user definable.

25. The computer readable medium of claim 22, wherein associating the document with the database field value includes coding the document in an electronic document review application.

26. The computer readable medium of claim 25, wherein the instructions are structured to cause the computing device to code the document with a first code if the gesture is a swipe in a first direction and coding the document with a second different code if the gesture is a swipe in a second different direction.

27. The computer readable medium of claim 26, wherein the first direction is opposite of the second direction.

28. The computer readable medium of claim 26, wherein the first code and the second code are user definable.

29. The computer readable medium of claim 25, wherein the instructions are structured to cause the computing device to code the document as at least one of privileged, responsive, not responsive, and hot.

30. The computer readable medium of claim 23, wherein the instructions are structured to cause the computing device to display the document in an electronic document review application.

31. The computer readable medium of claim 23, wherein the instructions are structured to cause the computing device to display the document on a desktop monitor and receiving the user gesture via the touch screen includes receiving the user gesture via a tablet device.

32. The computer readable medium of claim 23, wherein the instructions are structured to cause the processor to transmit the data indicative of the user gesture from the first computing device to the second computing device via a network.

33. The computer readable medium of claim 23, wherein the instructions are structured to cause the computing device to transmit the data indicative of the user gesture via the Internet.

34. A method of associating a document with a database field value, the method comprising:
displaying at least one of the document and metadata associated with the document on a touch screen display;
receiving a user gesture via the touch screen display; and
associating the document with the database field value based on the gesture.

35. The method of claim 34, wherein the user gesture is user definable.

36. The method of claim 34, wherein associating the document with the database field value includes coding the document in an electronic document review application.

37. The method of claim 34, wherein coding the document based on the gesture includes coding the document with a first code if the gesture is a swipe in a first direction and coding the document with a second different code if the gesture is a swipe in a second different direction.

38. The method of claim 37, wherein the first direction is opposite of the second direction.

39. The method of claim 37, wherein the first code and the second code are user definable.

40. The method of claim 34, wherein coding the document includes coding the document as at least one of privileged, responsive, not responsive, and hot.

41. The method of claim 34, wherein displaying the document on the touch screen display includes displaying the document in an electronic document review application.
